(19) United States
(12) Patent Application Publication
(10) Pub. No.: US 2012/0000078 A1
(43) Pub. Date: Jan. 5, 2012

(54) BARBER SCISSORS

(75) Inventor: Shigeru FUJITA, Tsubame-shi (JP)

(73) Assignee: SHIGERU INDUSTRY CO., LTD., Tsubame-shi (JP)

(21) Appl. No.: 13/172,101

(22) Filed: Jun. 29, 2011

(30) Foreign Application Priority Data
Jun. 30, 2010 (JP) 2010-148793

(51) Int. Cl. B26B 13/28

(52) U.S. Cl. 30/239

(57) ABSTRACT

An object of the invention is to achieve the practicable use of a pair of barber scissors having a sliding-cutting function. In the barber scissors configured of blade bodies each including a cutting blade and handle, a gear accommodation hole is formed at a pivotal joint intersection of one blade body; a rack is formed on the inner-surface of the gear accommodation hole; and a guide groove is formed in the outer-surface of the blade body. In the pivotal joint shaft position of the other blade body, a pinion having arc-shaped teeth to engage with the rack is mounted to rotate together with the blade body; a guide member having a projection to fit into the guide grove is disposed striding the outer-surface of the gear accommodation hole; and a nut is screwed and mounted on the pivotal joint screw shaft protruding from a shaft hole of the guide member.

### BACKGROUND OF THE INVENTION

1. Field of the Invention

The present invention relates to a pair of barber scissors in which two blade bodies that intersect each other for haircutting make sliding movement relatively to each other in haircutting operation.

2. Related Art

A well-known basic configuration of a pair of barber scissors includes two blade bodies, each having a cutting blade and a handle (a thumb/finger hole portion), that intersect each other in an X-shape state; a shaft hole that penetrates through the two blade bodies and is arranged at the intersecting point of the blade bodies; and a pivotal joint shaft, inserted in the shaft hole, that pivotally fastens the intersecting point so that the blade bodies can be freely operated in an opening-and-closing manner.

The barber scissors are mainly used by barbers for haircutting. Accordingly, scissors that are more easy-to-use and have better cutting quality are required. In order to meet such requirements, the scissors having a structure in which the cutting blades apply a shearing force while moving in a cutting edge direction (that is, a relative sliding-cutting structure, hereinafter referred to as “sliding-cutting structure”) are proposed. The scissors having a sliding-cutting structure are different from the scissors in the past that apply a shearing force orthogonal to hair to be cut.

As examples, the following structures are known: a structure in which a pivotal joint shaft is fixed to one blade body (lower blade body, operated by a thumb in use) while a pivotal joint portion of the other blade body (upper blade body, operated by a middle finger in use) is configured of an elongated hole so that the pivotal joint shaft is capable of moving in a cutting edge line direction and in which a groove that slants with respect to the cutting edge line direction and a projection corresponding to the groove are provided on an opposing sliding surface of the blade bodies (JP-A-10-179951); a structure in which two shafts are provided in an axial portion (serving as a pivotal joint) of a lower blade body while an insertion hole which is arranged in an upper blade body and through which the above-mentioned axial portion passes is formed in an arc shape or L-shape (JP-A-11-114242 and so on); a structure in which the pivotal joint shafts of an upper blade body and a lower blade body are arranged eccentrically (JP-B-04-59919); and so forth.

Since the aforementioned structure of sliding movement of the upper blade body is basically a structure of crank motion, a user feels discomfort in operation compared to the barber scissors usually used whose blade bodies make pivotal movement about a pivotal joint shaft. In other words, the user feels easy with a structure in which a rotational movement about the pivotal joint shaft and a sliding movement are coincident with each other in appearance. Therefore, a structure in which a pinion gear mounted on a pivotal joint shaft and a rack in the upper blade body are combined to implement sliding-cutting is also proposed (Patent references 1 and 2).

In Patent reference 1 (JP-UM-A-60-149382), a structure of a pair of scissors is described in which a large rectangular hole is provided at a pivotal joint portion of the upper blade body, a rack is formed on the inner periphery of the rectangular hole, along shaft hole is provided in the bottom surface (outer surface of the scissors) to affix a gear box therein, a pinion gear to engage with the rack is mounted on a pivotal joint shaft that is penetratingly disposed integrating the lower blade body, and a coupling pin is mounted on a shaft portion protruding from the long shaft hole to serve as a retaining pin.

Further in Patent reference 2 (JP-A-62-170284), a structure of a pair of scissors is described in which a large elongated hole is provided at a pivotal joint portion of the upper blade body, a rack is formed on the inner periphery of the elongated hole, a pinion gear integrally mounted in the lower blade body is incorporated into the elongated hole, and a nut is screwed on a pivotal joint shaft protruding from the pinion gear.

Listed below are reference documents.

Patent reference 1: JP-UM-A-60-149382
Patent reference 2: JP-A-62-170284

In the aforementioned sliding-cutting structure in which a pinion gear and a rack are engaged, the nut that is screwed on a pivotal joint shaft (gear shaft) works as a member to prevent the upper blade body from being decoupled, whereas at the same time, sliding motion between the upper and lower blade bodies takes place during haircutting operation; this sliding motion causes the nut to be loosened. As a result, pinching force applied to the upper and lower blade bodies is lessened, thereby reducing sharpness of the scissors.

If, instead of using a nut member, a pin member that does not cause the loosening is used as described in Patent reference 1, an adjusting function to achieve a desired pinching force cannot be equipped with.

In order to realize a smooth engagement between a pinion gear and a rack, the engagement having a slight margin is desirable rather than the engagement with no margin in which no shaky motion takes place; however, the engagement with a margin can cause undesirable shaky motion of the blade bodies during haircutting operation.

Furthermore, a sliding-cutting structure adopting a rack and pinion needs a space in a pivotal joint shaft portion for the movement of the pinion. However, small pieces of cut hair are likely to come into this space. Accordingly, if the small pieces of cut hair are not adequately removed, they are dragged into a sliding space and lessen the blade body operability.

A tip portion rather than a root portion (pivotal joint shaft side) of the cutting blade is used in haircutting operation. However, specific consideration is not given to the sliding movement of the tip portion of the cutting blade because the blade body rotation angle and the blade body sliding distance have a constant relationship in the sliding-cutting structure adopting a rack and pinion.

### SUMMARY OF THE INVENTION

The present invention provides a pair of barber scissors having a sliding-cutting structure adopting a rack and pinion. Although the barber scissors with a sliding-cutting structure adopting a rack and pinion have not actually been productized due to various problems, the barber scissors of the present invention can be put into practical use by having a novel sliding-cutting structure in which a combination mechanism of rack and pinion is much improved.

A pair of barber scissors according to a first aspect of the invention has a structure in which two blade bodies, each having a cutting blade and a handle, intersect each other in an X-shape state and the intersecting point is structured as a pivotal joint so that the cutting blades are made openable and closable, and includes: a gear accommodation hole adequately formed at the intersecting point of one blade body (usually formed in an upper blade body, so hereinafter referred to as “upper blade body” for convenience); a rack formed on the inner surface of the gear accommodation hole in a longitudinal direction of the blade body; a pinion that has arc-shaped teeth to engage with the rack and is arranged in a pivotal joint shaft position of the other blade body (lower blade body) so as to rotate together with the lower blade body; a guide member that has a projection to fit into a guide groove extended in a blade body handle direction on the outer surface of the upper blade body in the vicinity of the gear accommodation hole and that is disposed striding the outer surface of the gear accommodation hole; a shaft hole formed in the guide member through which a pivotal joint screw shaft passes in an upright fashion from the pinion; and a nut that is screwed and mounted on the pivotal joint screw shaft protruding from the guide member.

When the blade bodies are operated in an opening-and-closing manner, the upper blade body rotates while making a sliding movement relative to the lower blade body due to the engagement between the rack and the arc-shaped teeth of the pinion, whereby the cutting edges that intersect each other cut hair while making the sliding movement.

Specifically in the aforementioned configuration, because the nut is screwed and mounted on the guide member that moves together with the lower blade member (pivotal joint screw shaft) during haircutting operation, a pinching force adjustment of the pivotal joint shaft portion can be carried out as in the case of usual barber scissors, and in addition, the sliding movement of the blade body will not cause the nut to be loosened. Furthermore, because the guide member allows the upper blade body to make sliding movement along the guide groove, the engagement between the rack and the arc-shaped teeth of the pinion is made gentle so as to implement a smooth rotation and slide movement.

A pair of barber scissors according to a second aspect of the invention is configured by making the guide member of the scissors of the first aspect of the invention be formed in a shape to wall up only part of the gear accommodation hole and providing a through-hole in the lower blade body in a range corresponding to the gear accommodation hole. With this configuration, even if small pieces of cut hair come into the space inside the gear accommodation hole, they will be removed through the part that is not walled up by the guide member, the through-hole, and the like with ease.

Further, a pair of barber scissors according to a fourth aspect of the invention is configured by making the pinion of the scissors of the above-mentioned aspects of the invention be formed in a cam shape in which a radius from the pivotal joint screw shaft as a center to the position of an arc-shaped tooth of the pinion that engages with the rack is longer when an opening angle of the blade bodies is smaller whereas a radius from the pivotal joint screw shaft as the center to the position of an arc-shaped tooth that engages with the rack is shorter when the opening angle of the blade bodies is larger. With this configuration, a relative sliding movement distance between the blade bodies becomes longer when the cutting blade tip portions of the blade bodies, frequently used in haircutting, are being operated (at smaller opening angles), thereby increasing haircutting capability at the portions frequently used in haircutting.

The present invention, with the configuration described above, has improved the sharpness of the scissors by allowing the blade bodies to make sliding movement in haircutting operation. In addition, the invention has made it possible to adjust a pinching force with ease against the pivotal joint shaft portion so as to improve the sharpness of the barber scissors and meet requests of a user. As a result, the practicable use of a pair of barber scissors adopting a rack and pinion in a sliding-cutting structure has been achieved.

### BRIEF DESCRIPTION OF THE DRAWINGS

The invention will be described with reference to the accompanying drawings, wherein like numbers reference like elements.

FIG. 1 is an exploded perspective view of a pair of barber scissors according to a first embodiment of the invention.

FIG. 2 is a plan view of a pair of barber scissors according to the first embodiment.

FIG. 3 is a back side back view of a pair of barber scissors according to the first embodiment.

FIG. 4 is a plan view illustrating a principal portion of a pair of barber scissors according to the first embodiment (descriptive diagram of haircutting operation).

FIG. 5A is a plan view of a pinion of a pair of barber scissors according to the first embodiment.

FIG. 5B is a plan view of a pinion of a pair of barber scissors according to a second embodiment of the invention.

FIG. 6 is an exploded perspective view of a pair of barber scissors according to the second embodiment.

FIG. 7 is a plan view illustration a principal portion of a pair of barber scissors according to the second embodiment.

FIG. 8 is a plan view illustrating a principal portion of a pair of barber scissors according to the second embodiment (descriptive diagram of haircutting operation).

### DESCRIPTION OF THE PREFERRED EMBODIMENTS

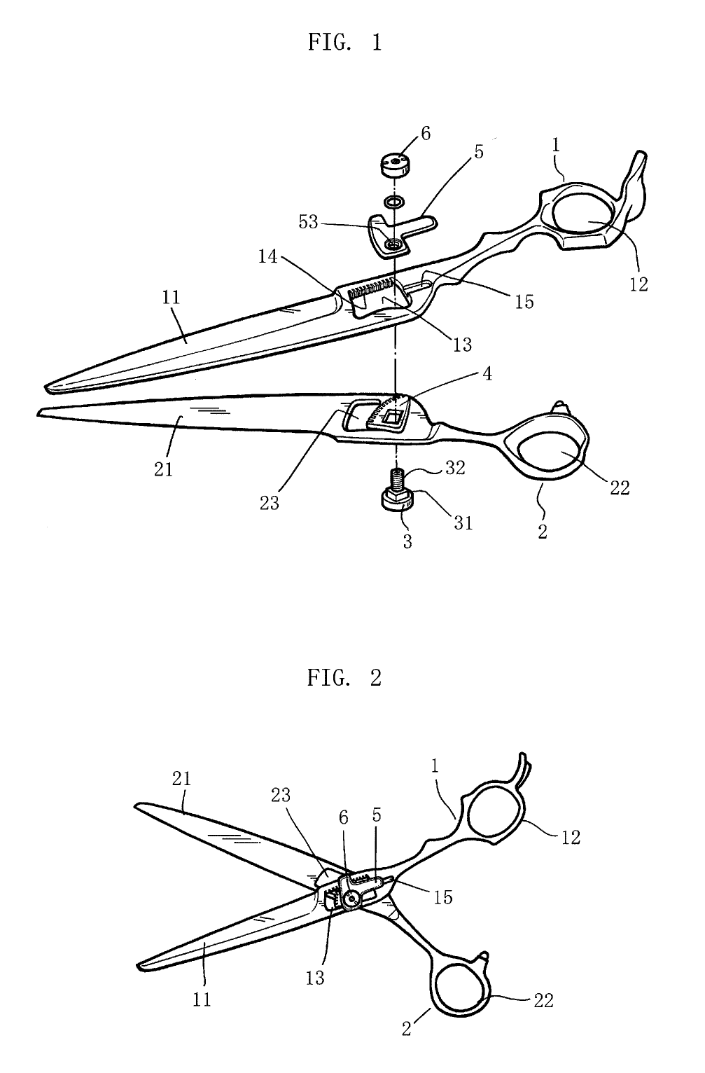

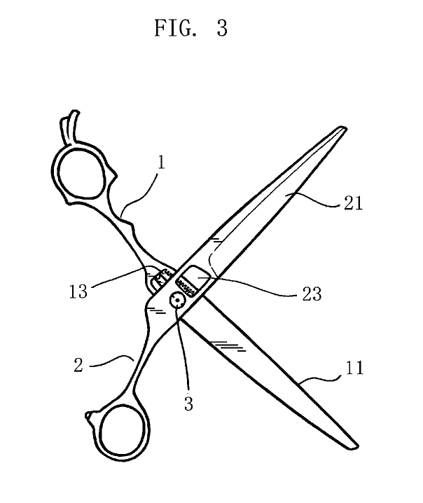

Hereinafter, the preferred embodiments of the invention will be described. FIGS. 1 through 4 indicate a first embodiment of the invention. A pair of barber scissors according to the first embodiment, as in the case of the past scissors, basically have two blade bodies 1 and 2 that intersect each other in an X-shape state at the intersecting portion as a pivotal joint structure so that cutting blades 11 and 21 opposing each other are made openable and closable; and include, in addition to the aforementioned blade bodies 1 and 2, a shaft member 3 that forms a pivotal joint structure of the intersecting portion, a pinion (pinion portion) 4, a guide member 5, and a nut 6.

The upper blade body 1 includes the cutting blade 11 and a handle (finger hole) 12, in which a gear accommodation hole 13 is adequately formed in an approximately rectangle shape at the intersection portion, a rack 14 is formed on an inner surface of the gear accommodation hole 13 on the cutting edge side in the blade body longitudinal direction, and an elongated guide groove 15 whose length is sufficiently large to correspond to a sliding movement range, mentioned later, from the edge on the handle side of the gear accommodation hole 13 to the outside surface of the upper blade body 1 is formed approximately on a center line in the blade body longitudinal direction of the gear accommodation hole 13.

The lower blade body 2 includes the cutting blade 21 and a handle (thumb hole) 22, in which a square hole (not shown) is formed in a pivotal joint shaft portion and a through-hole 23 is also formed in a predetermined range. The forming range of the through-hole 23 is set in a range precluding the square hole portion and corresponds to the gear accommodation hole 13; the size of the through-hole 23 is so determined as to prevent the pinion 4, explained later, from falling out the through-hole 23 when the pinion 4 is arranged on the back side surface (scissors friction surface) of the lower blade 2.

The shaft member 3, basically configured in the same manner as the pivotal joint shaft member of the past technique, includes a square shaft 31 and a pivotal joint screw shaft 32 which is extended from the square shaft 31, and onto which the nut is screwed so that the shaft member 3 rotates together with the lower blade body 2.

The pinion 4 includes a square hole 41 corresponding to the square shaft 31, is formed approximately in a quarter-circle fan shape centered on the square hole 41, and further includes arc-shaped teeth 42 on the outer circumferential portion thereof. The pinion 4 is arranged inside the gear accommodation hole 13 and is formed in a size such that it can travel along the rack 14 within an adequate range while the arc-shaped teeth 42 engage with the rack 14.

The pinion 4 may not be provided as an individual member and may be provided as a pinion portion that is directly affixed to the back side of the lower blade body 2. Furthermore, a pivotal joint screw shaft may be provided projecting from a predetermined position of the pinion portion.

The guide member 5 includes a striding portion 51 that is wider than the width (lateral direction) of the gear accommodation hole 13 and an arm portion 52 that corresponds to the guide groove 15 so as to be formed approximately in a T-shape. The guide member 5 further includes a shaft hole 53 in an appropriate position of the striding portion 51 to correspond to the pivotal joint screw shaft 32, and a projection 54 disposed on the back side of the arm portion 52 to fit into the guide groove 15.

The elements mentioned above serve to configure a pair of scissors in the following manner: the upper and lower blade bodies 1 and 2 are intersected at a pivotal joint structure portion; the shaft member 3 is inserted and fixed in a square hole of the lower blade body 2; the arc-shaped teeth 42 are engaged with the rack 14 at a predetermined position; the square shaft 31 is inserted and mounted in the square hole 41 so as to integrally combine the pinion 4 with the lower blade body 2; the pivotal joint screw shaft 32 is inserted in the shaft hole 53; the projection 54 is fitted into the guide groove 15; and the nut 6 is screwed and mounted on the pivotal joint screw shaft 32 protruding from the upper surface of the guide member 5 that is arranged striding the gear accommodation hole 13.

In the aforementioned pair of barber scissors, the upper blade body 1 rotates relative to the lower blade body 2 while making sliding movement due to the engagement between the rack 14 and the arc-shaped teeth 42 of the pinion 4 when an opening-and-closing operation is performed as usual. Therefore, hair is shorn not only by rotational movement but also by sliding movement.

The position of the nut 6 was on the upper surface of the upper blade body 1 in the pivotal joint shaft portion in the past technique; in the present embodiment, it has been changed to the upper surface of the guide member 5. Accordingly, it is a matter of course that a pinching force adjustment can be carried out as in the case of the past scissors. Furthermore, a structure for preventing the nut 6 from being loosened, for which various methods have been proposed, can be incorporated without difficulty.

Further, in the pair of barber scissors according to the embodiment, because the guide member 5 is formed so as to wall up only part of the gear accommodation hole 13 and the through-hole 23 is provided in a range corresponding to the gear accommodation hole 13 in the lower blade body, there is provided a sufficient space penetrating the blade bodies 1 and 2 in the pivotal joint structure portion. Therefore, although small pieces of cut hair are likely to come into the space mentioned above, they can easily go out of the space themselves and can be completely removed by brushing without disassembly of the scissors after haircutting operation.

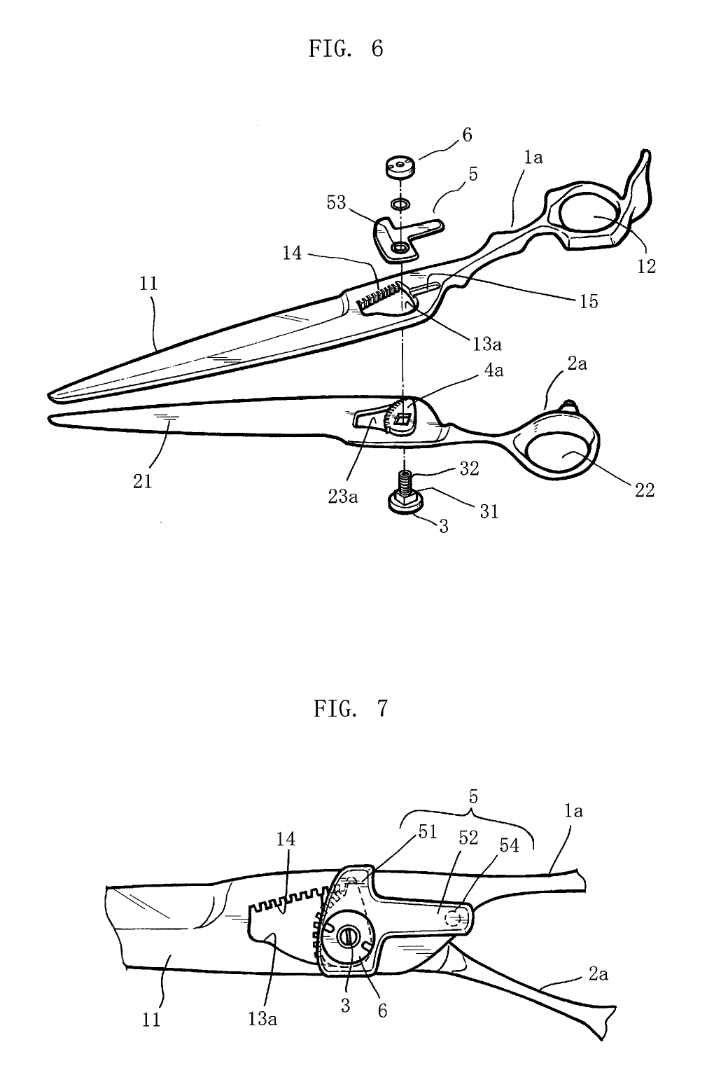

Next, a pair of barber scissors according to a second embodiment will be described with reference to FIGS. 6 through 8, in which a pinion 4a includes particularly outstanding features.

That is, the arc-shaped teeth 42 of the pinion 4 of the first embodiment are arranged forming a circular arc and the rotation angle of the pinion 4 is proportional to the distance of sliding movement. However, in the barber scissors, a tip portion of the cutting blades is mainly used during haircutting; therefore, in order to increase the sharpness of the scissors, it is preferable that the distance of sliding movement be made longer when the tip portion is being used, thereby increasing the effect of the sliding movement.

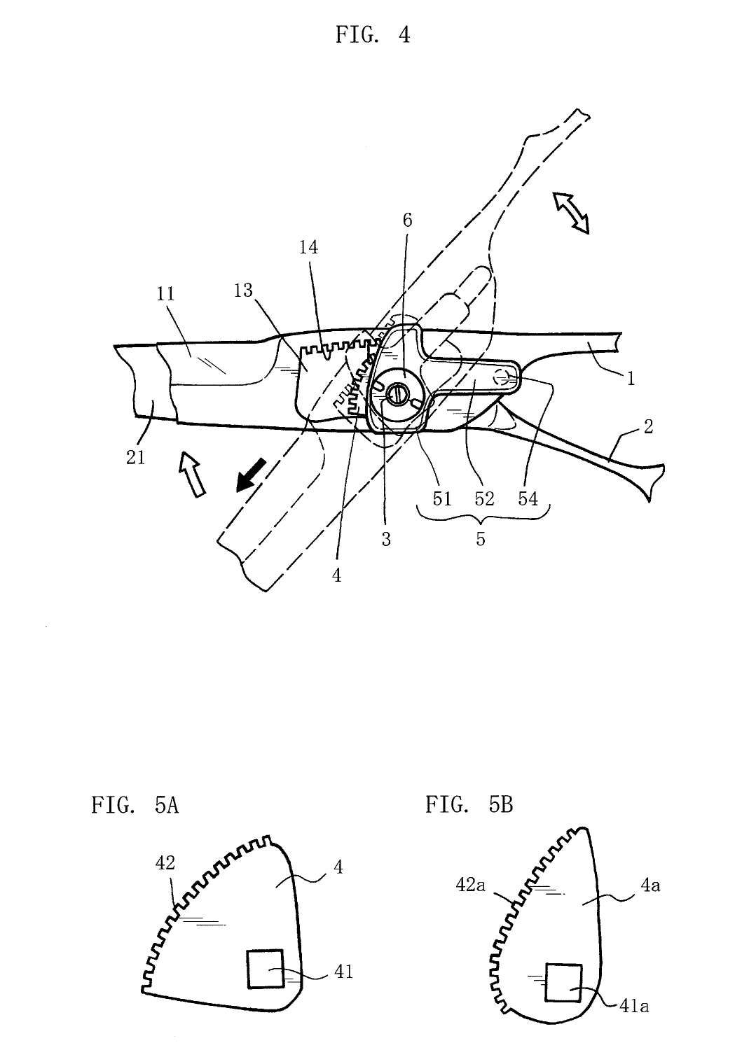

In the second embodiment, as shown in FIG. 5B, a distance from the center of a pivotal joint shaft (center of a square hole 41a) to each of arc-shaped teeth 42a of the pinion 4a is made to change gradually.

That is to say, the pinion 4a is formed in a cam shape in which a radius from the shaft member 3 as a center to the position of an arc-shaped tooth 42a of the pinion 4a that engages with the rack is longer when an opening angle of the blade bodies 1 and 2 is smaller, whereas a radius from the shaft member 3 as the center to the position of an arc-shaped tooth 42a that engages with the rack is shorter when the opening angle of the blade bodies is larger.

Along with the adoption of the pinion 4a, a gear accommodation hole 13a in an upper blade body 1a is formed in a shape corresponding to the movement track of the pinion 4a while a through-hole 23a in a lower blade body 2a is also formed in an appropriate shape. As for other elements in the configuration, like numbers are used to indicate like and corresponding elements in the first and second embodiments.

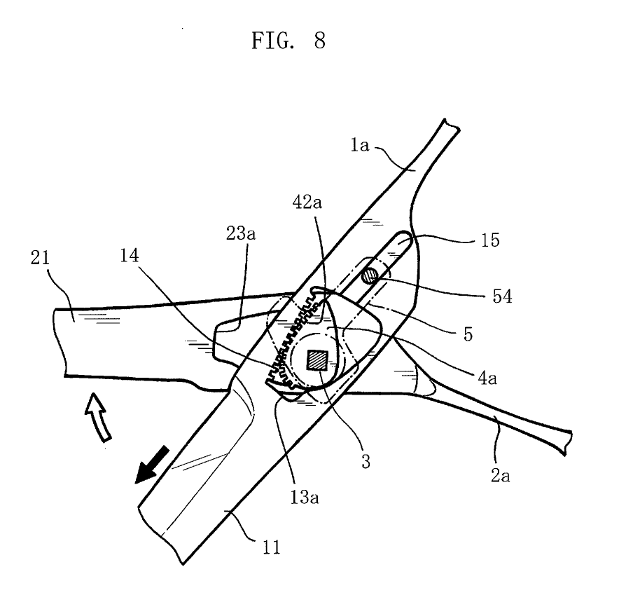

When the engagement between the rack 14 and the arc-shaped teeth 42a changes from the state in which the upper and lower blade bodies 1a and 2a are opened as exemplified in FIG. 8, to the state in which the two blade bodies 1a and 2a are closed as in FIG. 7, a distance of sliding movement per rotation angle becomes longer as the opening-and-closing angle of the two blade bodies becomes smaller. This makes the cutting at the tip portion of the cutting edges more effective due to the sliding movement.

### NUMERALS

1, 1a upper blade body
11 cutting blade
12 handle (finger hole)
13, 13a gear accommodation hole
14 rack
15 guide groove
2, 2a lower blade body
21 cutting blade
22 handle (thumb hole)
23, 23a through-hole
3 shaft member
31 square shaft
32 pivotal joint screw shaft
4, 4a pinion
41 square hole
42, 42a arc-shaped teeth
5 guide member
51 striding portion
52 arm portion
53 shaft hole
54 projection
55 nut

What is claimed is:

1. A pair of barber scissors having a structure in which blade bodies, each including a cutting blade and a handle, intersect each other in an X-shape state and the intersecting point is structured as a pivotal joint so that the cutting blades are made openable and closable, the pair of barber scissors comprising:
a gear accommodation hole adequately formed at the intersecting point of one blade body;
a rack formed on the inner surface of the gear accommodation hole in a longitudinal direction of the blade body;
a pinion that has arc-shaped teeth to engage with the rack and is arranged in a pivotal joint shaft position of the other blade body so as to rotate together with the other blade body;
a guide member that has a projection to fit into a guide groove extended in a blade body handle direction on the outer surface of the one blade body in the vicinity of the gear accommodation hole and that is disposed striding an outer surface of the gear accommodation hole;
a shaft hole formed in the guide member through which a pivotal joint screw shaft passes in an upright fashion from the pinion; and
a nut that is screwed and mounted on the pivotal joint screw shaft protruding from the guide member.

2. The pair of barber scissors according to claim 1,
wherein the guide member is formed so as to wall up only part of the gear accommodation hole and a through-hole is provided in the other blade body in a range corresponding to the gear accommodation hole.

3. The pair of barber scissors according to one of claims 1 and 2,
wherein the arc-shaped teeth of the pinion are arranged on a circumference of an approximate quarter-circle fan whose center is the pivotal joint screw shaft.

4. The pair of barber scissors according to one of claims 1 and 2,
Wherein the pinion is formed in a cam shape in which a radius from the pivotal joint screw shaft as a center to the position of an arc-shaped tooth of the pinion that engages with the rack is larger when an opening angle of the blade bodies is smaller whereas a radius from the pivotal joint screw shaft as the center to the position of an arc-shaped tooth that engages with the rack is shorter when the opening angle of the blade bodies is larger.
